(19) United States
(12) Patent Application Publication
(10) Pub. No.: US 2023/0243263 A1
(43) Pub. Date: Aug. 3, 2023

(54) AXIAL OUT-RUNNER TURBINE AND METHOD FOR MANUFACTURING A ROTOR SECTION FOR THAT TURBINE

(71) Applicant: Intelligent Power Generation Limited, Greater London (GB)

(72) Inventors: John Grainger, Hoddesdon (GB); Geoff Smith, Reigate (GB); Tristram Bracey, Hove (GB); Chris Spacie, Swansea (GB)

(21) Appl. No.: 17/040,352

(22) PCT Filed: Mar. 26, 2019
(86) PCT No.: PCT/GB2019/050863

§ 371 Date: Sep. 22, 2020

(30) Foreign Application Priority Data
Mar. 27, 2018 (GB) 1804912.2

(51) Int. Cl. F01D 5/03; F01D 5/28; C04B 35/591; C04B 35/573

(52) U.S. Cl. CPC F01D 5/03; F01D 5/28; C04B 35/591; C04B 35/573; F05D 2300/2283; F05D 2300/2261; C04B 2235/3873; C04B 2235/3826; C04B 2235/428

(57) ABSTRACT

The invention relates to an axial turbine with a rotating casing and stationary shaft, sections for the assembly thereof, and materials for the manufacture thereof.

### BACKGROUND

An axial turbine is a rotating machine which extracts useful shaft work from a motive fluid which is supplied to the turbine typically at high pressure and temperature, flowing generally axially along the device. Typical axial turbines use stationary (stator) and rotating (rotor) aerodynamic blades; the stators converting the supplied pressure into swirl velocity, and the rotors extracting that velocity due to the aerodynamic blade forces acting through a rotational movement. It is customary that such turbines consist of many stages of alternate stator and rotor sections, and that the rotors are affixed on their radially inner-most point to a rotating central shaft and the stators are affixed on their radially outermost point to a stationary casing. This conventional layout can be termed an “in-runner”, to denote that the inner rotor sections rotate whilst the outer casing is stationary.

An alternative arrangement is PCT application WO 2013/113324, which depicts a statorless gas turbine with a rotating casing, with the rotors mounted to that casing instead of being mounted to a central shaft. (In some embodiments therein, a central shaft may be provided as a static fixation member.) This makes it more viable to use ceramic materials in the rotor blades since it means that, whereas hub-mounted rotor blades would be under high tensile stress due to centrifugal force, casing-mounted rotor blades would instead be under compressive stress. In this arrangement, the tensile forces instead manifest in the rotating casing rather than blades. Such a layout can be termed an “out-runner”, as distinct from the above-described “in-runner” turbine design.

It has been known for many years that engineering ceramics could allow for a very high temperature turbine inlet flow, thereby boosting the efficiency and power density of a power generation cycle. Ceramics are known to offer good mechanical properties at such high temperatures compared to the metal alloys more conventionally used in turbines, but usage of ceramics in axial turbines is still very rare by comparison largely since they have been difficult to integrate into the front-lines of engine design due to their very different design requirements.

PCT/GB2017/052850 depicts a fully ceramic turbine including a structural sheath made from a denser, stronger ceramic material than the rotor and stator sections. (The definitions of the term Dense for the purposes herein are defined as per PCT/GB2017/052850.) A dense ceramic sheath provides improved structural support to the turbine assembly, allowing faster tip speeds for the rotating components. However, such denser ceramics are more difficult and expensive to manufacture and are not as suited to the complex geometries required in the stator and rotor sections as less dense ceramics. The difficulties and complex manufacturing process results in a high manufacturing cost for the turbine assembly.

In order to function at high temperatures, both conventional in-runner turbines and out-runner turbines using metal components need to be constructed of expensive exotic metal alloys, and either suffer from limited operating temperatures (below about 1,100° C., which limits the power generation efficiency) or else require complex capillary channels to blow cooling air through the blades to retain their mechanical strength. Cooling channels add substantial complexity to turbine blade design and manufacture, add a parasitic compressor load to power the air flow, and cannot be easily fit into the very thin and small blades typical in micro-turbines (i.e. gas turbines with net power output below about 1 MW).

Fully ceramic turbines such as PCT/GB2017/052850 allow operation above 1,100° C. without exotic metal alloys or cooling channels, thus greatly reducing blade cost and complexity whilst allowing high performance, even for micro turbines with thin and small blades. PCT/GB2017/052850 takes advantage of using a structural sheath made from a denser, strong ceramic material, combined with rotor and stator sections which are made from a lower density ceramic material more suited to manufacturing into complex geometries. Despite this benefit, the turbines of PCT/GB2017/052850 require a lower rotational speed than typical metal designs of the same power, so typically below about 20,000 rpm, rather than often around 100,000 rpm. To retain the same power and efficiency, this increases the number of turbine stages, making the turbine axially longer and requiring more parts.

### SUMMARY OF INVENTION

The applicant has unexpectedly discovered that it is possible to remove the dense structural sheath of the turbine design described in PCT/GB2017/052850 and use only less dense ceramics for the complete turbine assembly. By manipulating the radius, speed and number of stages a turbine of the same design described in PCT/GB2017/052850 can be constructed without a structural sheath. This choice of whether or not to use a sheath has advantages and disadvantages, and both PCT/GB2017/052850 and the featured invention are appropriate for different circumstances as herein described. A ceramic out-runner turbine with no structural sheath can still operate at higher temperatures than turbines with metallic parts without the complexity of cooling channels, and will be cheaper to manufacture than if using a sheath. Without a sheath however, the tip speed may need to be reduced, resulting in less work extracted from each stage, requiring that the number of turbine stages be increased, or else that the blade angles have greater flow turning, in either case lowering the turbine's efficiency. The cost to benefit ratio for using or not using a sheath depends on the chosen market (for example automotive markets may be more constrained by cost and/or size than efficiency, whereas for stationary power generation purposes size is much less constrained and superior efficiency is preferred to lower manufacturing costs), and volume of production (for example, the ability to injection mould dense ceramics requires greater compensation for shrinkage).

Despite a lack of a dense ceramic sheath, a fully ceramic out-runner arrangement is still unique and beneficial over a ceramic in-runner arrangement for the following reasons. The benefit comes because the tensile stresses in the rotating rotor hub casing are very uniform, easy to predict, and can be made thicker externally without impacting the flow path. By contrast with an in-runner arrangement, tensile stresses manifest in the rotor blades, for which the complex geometry would create stress concentrations combined with thin sections that are prone to manufacturing flaws, surface oxidation, and foreign body impact. A ceramic out-runner arrangement where the blades are in compression is more resistant to these problems. An additional benefit is that, as rotor blades creep with applied stress and high temperature, an out-runner arrangement causes the rotor to deform over time away from the stator, creating merely a larger tip leakage, whereas an in-runner arrangement where the rotor blades lengthen toward the casing will eventually foul, potentially causing catastrophic failure without warning.

Where a sheath is used, the rotor sections are fitted to the inside of the sheath, and the rotor sections and sheath are arranged to rotate together, such that the sheath and rotor sections retain a consistent positioning relative to each other.

### DESCRIPTION OF FIGURES

FIG. 1 depicts a cross-section of an axial turbine.

FIG. 2 depicts an exterior view of the axial turbine of FIG. 1.

FIG. 3 depicts a cross-section of another axial turbine, depicting the sheath feature.

FIG. 4 depicts RBSN manufacturing techniques based on cold pressing.

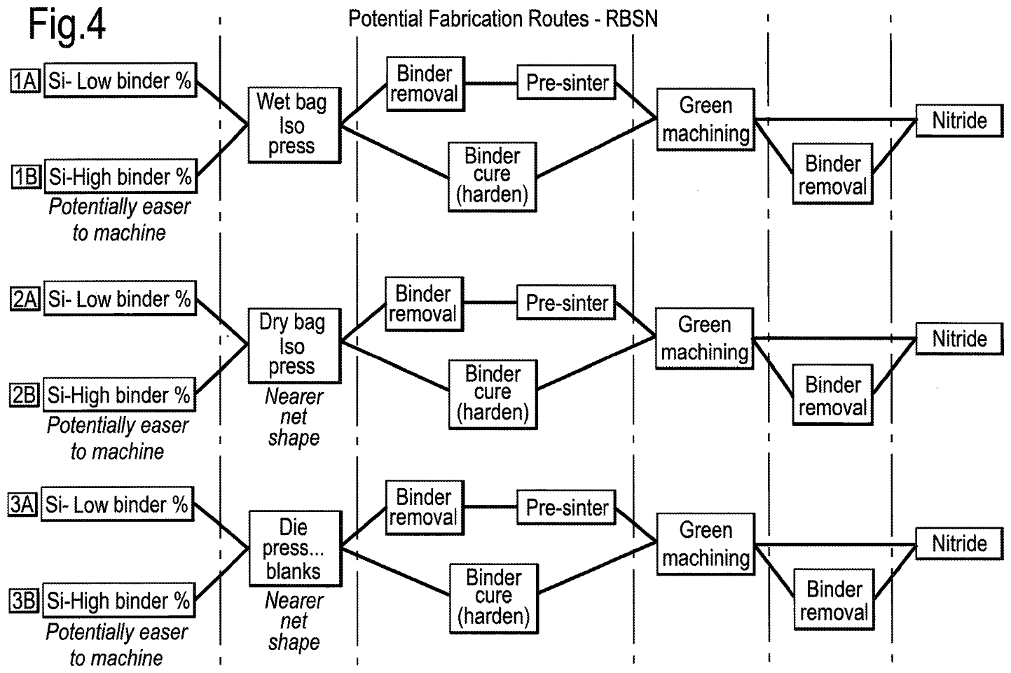

FIG. 5 depicts RBSN manufacturing techniques based on casting.

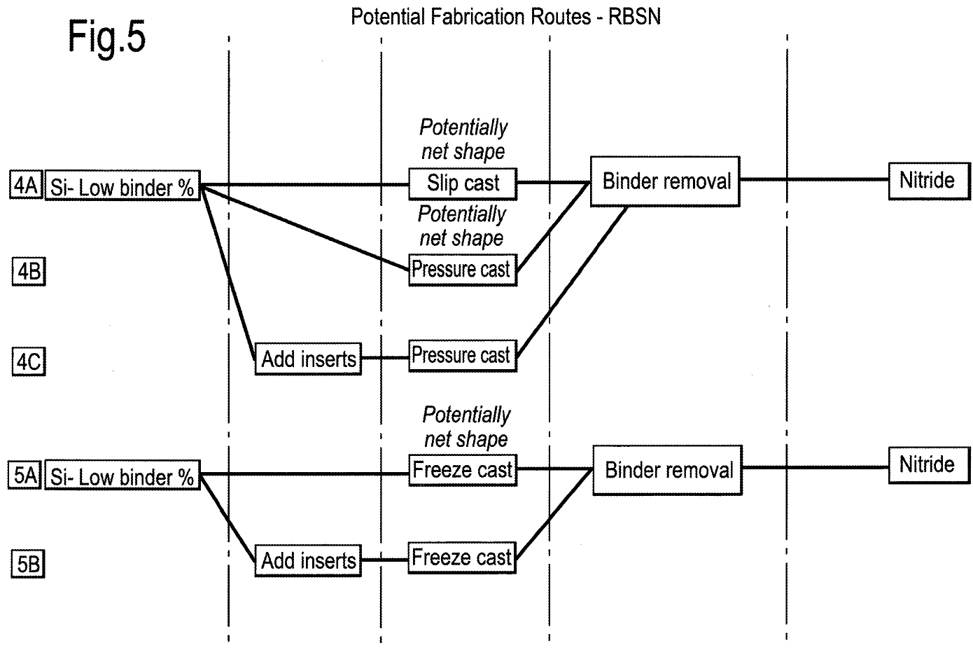

FIG. 6 depicts RBSN manufacturing techniques based on injection moulding or flame spraying.

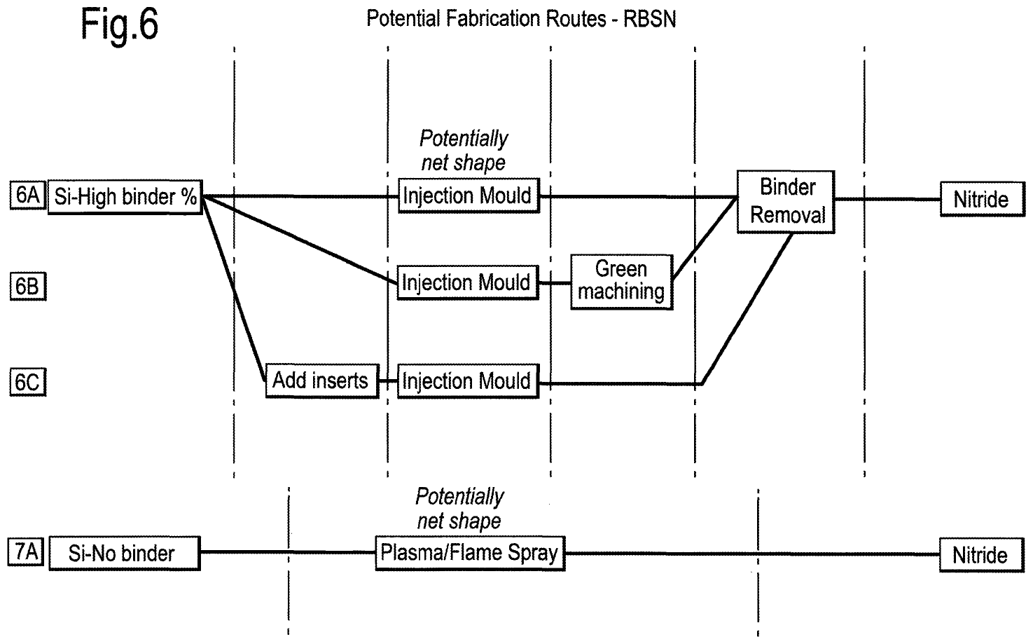

FIG. 7 depicts RBSN manufacturing techniques based on additive manufacture or sol-gel methods.

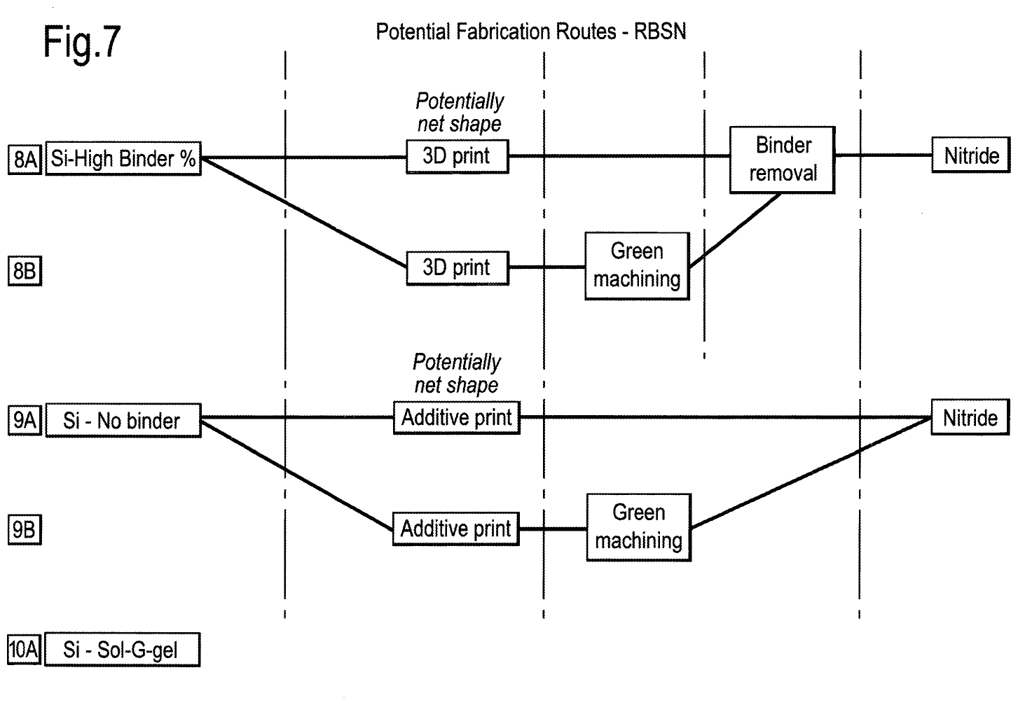

### DETAILED DESCRIPTION

As far as ceramic turbines are concerned, one acceptable material is Dense Silicon Nitride (DSN), which commonly refers to a broad class of ceramics composed predominantly of silicon nitride (Si3N4), usually in beta (β) hexagonal crystallographic form. The densification is usually achieved by the addition of small amounts of metal oxides to aid the formation of a liquid phase at high temperatures which enables the silicon nitride granules to re-arrange under applied pressure and temperature to densify by liquid phase densification (ref. Kingery W. D., Bowen H. K., Uhlmann D. R., “Introduction to Ceramics”, pub. John Wiley & Sons. ISBN 0-471-47860-1). Commercial DSN ceramics would be expected to have a density above 96% of the theoretical density. High temperature mechanical performance is generally controlled by the sintering aids used to help densify the ceramic. The use of more refractory glasses, minimal quantities of sintering additives (typical when the ceramic densification is assisted by the application of pressure at high temperature) or the post fabrication devitrification of the intergranular glass all improve the resistance to creep at elevated temperature. Included in this class of ceramics is PSSN (pressureless sintered silicon nitride), SSN (sintered silicon nitride), HPSN (hot pressed silicon nitride), GPSN (gas pressure sintered silicon nitride), HIPSN (hot isostatically pressed silicon nitride), and SPSSN (spark plasma sintered silicon nitride). Examples of suitable ceramics include, but are not limited to, SN282 and SN240 as provided by Kyocera Ltd, NT154 as provided by Coorstek Ltd, and Gas-Pressure-Sintered Silicon Nitride (GPS-SN) as provided by FCT Ingenieurkeramik GmbH.

Another suitable class of materials is that of Sia Ion ceramics. Sia Ion ceramics may be considered a subset of the dense silicon nitride ceramics. The commonly exploited ceramics being generally an expanded beta (β) hexagonal Si₃N₄ lattice with the formula Si_{6-z}Al_{z}O_{z}N_{8-z}, where z is typically greater than 1.5 (but can be expanded to over 4). It is usual to achieve densification by the addition of combinations of metal oxides or other appropriate liquid sintering aids. Sialon ceramics differ from the dense silicon nitride ceramics described above in the extent of the lattice distortion that is achieved by incorporation of some of the cations from the densification aids within the silicon nitride lattice. Another suitable material that can be regarded as a type of dense silicon nitride is Sintered Reaction-Bonded Silicon Nitride (SRBSN). This is a type of reaction-bonded silicon nitride (RBSN) as described below which has been subjected to a sintering process; in the production of this metal oxides are added to the starting Si metal powder as sintering aids. Thus after conversion of the Si to Si₃N₄ below 1450° C. it is possible to achieve some densification by increasing the temperature. This is concurrent with shrinkage (typically <10%) and the reduction of porosity. As a result of this sintering, whilst the density of SRBSN is typically below 96% of the theoretical silicon nitride density, at the same time SRBSN has an intermediate density above that of RBSN. As a result, it is suitable for use as a sheath material in turbine assemblies according to PCT/GB2017/052850 due to having a density in excess of that of the rotor sections produced from RBSN. The turbine assembly of PCT/GB2017/052850 includes an exterior sheath that structurally supports the rotor sections and is adapted to rotate with them, and is made from dense silicon nitride. Dense silicon nitride materials suitable for this purpose include, but are not limited to, any of the above described dense silicon nitride materials, including Gas Pressure Sintered Silicon Nitride materials, Sialon ceramics and SRBSN, Preferably, the dense silicon nitride material used for the sheath has a density above 96% of the theoretical density. More preferably, the dense silicon nitride material used for the sheath has a density above 98% of the theoretical density.

A variety of fabrication techniques can be used to produce turbine components comprising DSN and Sialons ceramics. The fabrication stages for a component can be considered as Green Formation, Densification and Finishing, described as follows.

Green formation is where the ceramic powder, after mixing with the sintering aids and generally a fugitive binder, are formed into the basic product shape. These include but are not limited to slip-casting, pressure-casting, freeze-casting, injection moulding, die pressing, viscous plastic processing and isostatic pressing. A machining step may follow the initial shape formation. Densification is a process which applied heat and optionally pressure. This may be preceded by a low temperature heat treatment stage depending upon the green formation route used and the formulation. At this stage of the process a linear shrinkage of 18 to 22% is typical. Finishing is necessary for any surface finishes required other than ‘as fired’, or to ensure close dimensional tolerances. It is normal to machine the component by diamond grinding or polishing.

Preferably, for the full assembly of the claimed invention Reaction Bonded Silicon Nitride (RBSN) is used. Reaction Bonded Silicon Nitride (RBSN) is almost unique amongst ceramics and differs from dense silicon nitrides (DSN) both in formation route and in the fact that RBSN is porous (typically having a porosity of 10 to 30%).

One manufacturing method for RBSN is to machine shapes from a suitable silicon solid billet (said billets formed by cold-pressing a suitable silicon powder through dry or wet bag isopressing or die pressing) prior to conversion to a nitride form via firing in a nitrogen containing atmosphere. Machining in silicon powder compact phase (which may or may not have been pre-sintered to increase strength and to reduce porosity) greatly reduces the tooling cost compared with diamond grinding in a harder, more brittle ceramic phase. This is much like the “green formation” stage described above. Prior to machining in the green state a binder removal and pre-sintering phase may be required. Alternatively the binder fraction in the original silicon powder can be increased before the pressing stage. This allows binder curing, or polymerisation, which hardens the component making it easier to machine and avoids the pre-sintering stage. The heating process in the nitrogen containing atmosphere takes place at a temperature sufficient to convert the silicon (Si) metal to silicon nitride ceramic. The conversion process results in dimensional changes of up to 1%, thus minimising internal stresses and requires little or even no further expensive finishing, and minimising the difficulty of compensating for shrinkage. As a result, the nitride heating process causes minimal shrinkage compared with other sintering processes, thus minimising internal stresses, requiring no further machining and little (or even no) expensive further finishing after firing, and the difficulty of compensating for shrinkage is largely eliminated.

Alternatively, the silicon material (such as silicon powder with a suitable carrier) can be plastically deformed to form a shape, commonly injection moulded would be used, and due to the low shrinkage again requires no or very little further machining after firing. Machining of the green state, before binder removal, can take place for certain components. Such components require a higher fraction of binder to give added strength to the green state. The Si metal powder metal compact can be sintered to enable final shapes to be produced by conventional metal machining processes (instead of diamond grinding). Optionally inserts can be added to the polymer mould before injection moulding such that the component is moulded around the inserts, commonly referred to as insert injection moulding or overmoulding. These inserts may be components pre-made by other manufacturing methods or from a different ceramic material that is compatible, i.e. through similar shrinkage properties or through geometrical allowances for different shrinkages. The inserts may be moulded into the outer ring of the rotor section, or one or more of the rotor blades of the rotor section, or both.

Optionally, the fabrication stage can use liquid processing routes which may reduce the need for green state machining. Such techniques include slip casting, pressure casting or freeze casting. The silicon material can be mixed with a material to form a slip and poured into a plaster mould similar to the net shape of the component. The slip is left for a suitable period of time to allow enough liquid removal before the slip is removed leaving a solidified porous Si deposit around the plaster mould. Alternatively the silicon slip can be pressure cast, analogous to injection moulding, using a porous polymer mould with which the slip is injected into and a vacuum is used to remove excess liquid. Optionally inserts can be included analogous to insert injection moulding. Alternatively the slip can be formulated to be freeze cast. The slip is poured into a suitable mould and the temperature of the mould is dropped (for example by placing in a liquid nitrogen freezer). Upon warming the liquid part of the slip will melt away leaving only the solid component.

Other fabrication techniques which may allow fabrication of complex shapes and remove the need for green state machining include additive manufacturing techniques such as 3D-printing or additive printing. For example the net shape could be 3D-printed, with the silicon material mixed with a suitable carrier and built up in layers. Alternatively, additive printing could be used, where each built up layer of silicon material is partially sintered with a laser. Alternatively, a sol-gel fabrication stage could be adopted where a two input substances, typically in liquid form, are reacted together forming the silicon material in component shape desired. Error! Reference source not found., Error! Reference source not found., Error! Reference source not found. and Error! Reference source not found. show block flow visualisations of potential manufacturing processes as described in previous paragraphs.

‘Green shapes’ can be readily prepared by flame/plasma spraying. Negligible glass is present in the finished ceramic (as opposed to metal oxide additives being used during the formulation and fabrication), thus improved high temperature creep resistance is expected. The primary application limitation results from the residual open porosity which is susceptible to corrosion or oxidation depending upon the local atmosphere. As a result, RBSN, tends to have inferior mechanical properties to higher density silicon nitrides such as those formed by sintering, which generally have far greater manufacturing costs due to expensive grinding and more process steps (necessitated by the greater degree of shrinkage), or otherwise the substantial cost and time of adjusting injection moulds to correctly compensate for shrinkage. As such, RBSN is thus more viable for parts with higher part complexity compared with DSN, provided that allowance is made for their potentially inferior mechanical properties. In the context of PCT/GB2017/052850, and the present invention, the rotor sections and (preferably) the stator sections are made from RBSN.

The broad category of materials defined as silicon nitride encompasses but is not limited to Dense Silicon Nitrides, Sialon materials, RBSN, and SRBSN (wherein Sialon materials and SRBSN are types of dense silicon nitride). These all share similar thermal expansion properties, high strength (and capacity to withstand force or pressure) and creep resistance at high temperatures relative to metals, and good thermal shock properties relative to other ceramics. As widely cited with most ceramics, silicon nitride materials are far better at resisting compressive loading than tensile loading.

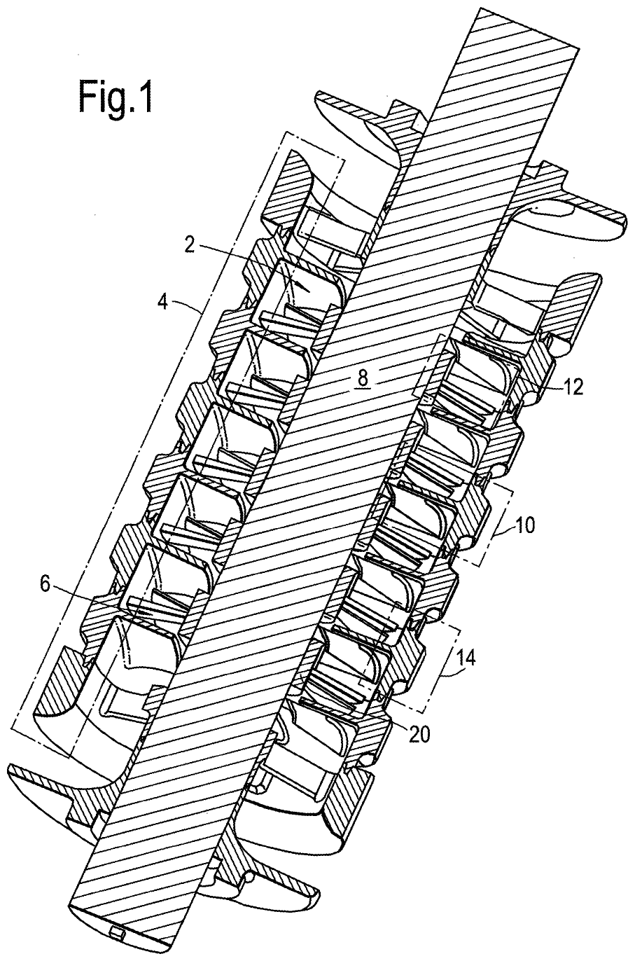

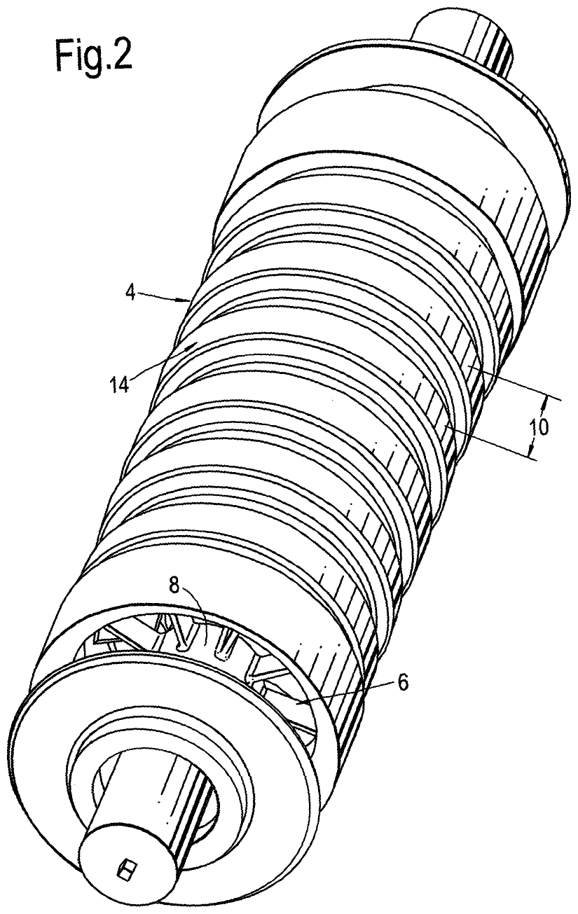

Unlike conventional in-runner axial turbines, which use rotor blades attached to a rotating shaft with stator blades attached to the surround casing, the turbine depicted in FIGS. 1 and 2 reverses this by attaching the rotor blades 2 to outer rings 14 which connect to form an outer casing 4 which all rotate together, and attaching the stator blades 6 to a shaft 8 which does not rotate, and is therefore a type of out-runner turbine.

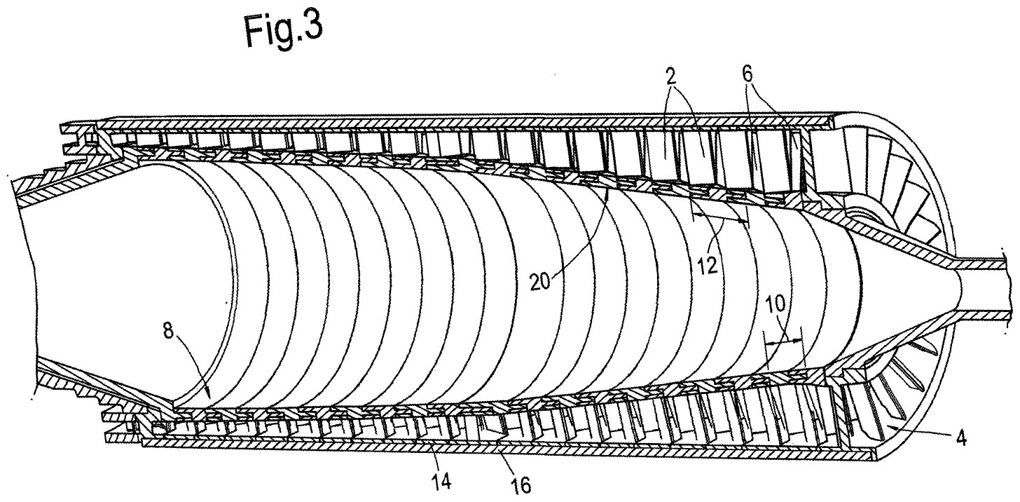

The turbines in FIGS. 1 and 2 comprise rotor sections 10 and stator sections 12. The rotor sections comprise aerodynamic rotor blades 2 are positioned radially inside an outer circular ring 14. In one embodiment of the present invention, as depicted in FIGS. 1 and 2, when fitting adjacent rotor sections 10 together, the outer rings 14 connect to form a continuous outer cylinder or casing 4. Other turbines according to the present invention could have a different tubular form to the casing, such as a conical shape, optionally with some axial variation in thickness. The turbine in FIG. 3 is much like the turbines in FIGS. 1 and 2 save that it incorporates the optional sheath feature 16.

Space is left between the rotor blades 2 for the stator blades 6. The stator sections 12 comprise the stator blades 6 comprised on an inner hub 20. The inner hubs 20 of the stator sections 12 fit together to form the shaft 8 which is locked from rotation. (The shaft 8 may be locked from rotation by the casing 4). Typically, the process of assembly involves placing the rotor sections 10 and stator sections 12 alternately, to form two concentric assemblies with blades.

In some embodiments of this invention, rotor sections 10 and stator sections 12 are formed as monolithic pieces, each incorporating many blades—typically 20 to 60. Alternatively, some embodiments of the invention may allow for the attachment of individual blades, or the attachment of an assembly of a small number of blades, to a common hub for ease of manufacture.

In some embodiments of this invention, rotor rings 14 and/or stator sections 12 incorporate a form of keyway or other non-planar interface to mutually transmit torque, rather than relying on friction from the fitting of the casing 4.

The arrangement of a stationary shaft 8 and a rotating outer assembly, means that in operation a compressive centrifugal force operates on the rotor blades 2, rather than putting them under tension as they would be if mounted on a rotating central shaft as in a conventional turbine. This is preferable if producing rotor blades 2 from ceramic materials, since ceramics tend to be more prone to fracture and creep when under tension. The placement of the rotor blades 2 on the outer casing 4 therefore reduces the mechanical demands on the rotor blades compared with a conventional arrangement.

Under the rotational loading, the casing 4 is in tension, which permits for a much simpler blade geometry to be used and hence a superior structural efficiency—that is, in operation a greater proportion of the turbine approaches the maximum limit for allowable stress, so that no material is needlessly operating below capacity. The simpler blade geometry also means that there are no stress concentrations as would be typical in more complex geometries. Such geometries are also simple and inexpensive to produce and grind to a smooth finish, minimising the effect of surface flaws in potential crack initiation. The innovative geometry offered by the novel design offers more opportunities to fabricate via lower cost techniques and to use a combination of ceramics not normally associated with turbine assemblies.

These features (placement of the rotor blades 2 on the casing 4 and having the casing under tension) allow the blades to be spun at higher speeds, increasing the stage work and thus reducing the number of stages, and hence weight, required for the same power (i.e., the power to weight ratio is improved), with consequent benefits for material cost. It also allows the same aerodynamic load to be obtained from thinner blades—for example as little as 1 mm or 2 mm thick—allowing the use of more blades per stage. Higher blade counts provide an optimal ratio of blade axial length to pitch when coupled with a reduced axial length, so using thinner blades reduces the overall length and weight of the turbine without affecting efficiency, which is particularly useful for vehicle applications.

Torque can be extracted from the rotating portions of the turbine in various ways, including but not limited to belts or gears attached to the rotating portion, or cantilevering the stator shaft 8 at one end and connecting the rotor back to a rotating shaft at the other end and/or back through the stator assembly, or having the stator assemblies as two separate cantilevers meeting in the middle, allowing the middle rotor stage to connect to a rotating central shaft which passes through both the stators.

Optionally, the outer rings 14 of the rotor sections 10 and/or the inner hubs 20 of the stator sections 12, may comprise shrouds to limit tip leakage. Optionally, shrouds may instead be provided by the provision of additional ring and/or hub sections designed so as to interface with the rotor sections 10 and/or stator sections 12, or provided on the rotor sections 10 and/or stator sections 12 by incorporating an additional ring attached to and connecting together the inside of the rotor blades or outside the stator blades. This limits tip leakage and annular losses and provides additional structural stiffness to the blades.

Either of the rotor sections 10 or stator sections 12 may or may not facilitate annular flare of the flow path, thereby creating conical assemblies, as is customary to retain a constant axial velocity as the flow reduces in pressure through the turbine.

Optionally, the rotor sections 10 and stator sections 12 are made from RBSN, which can be cheaply manufactured despite possessing a complex geometry. This results in the ability of the outer part of the rotor section being able to deal with stresses up to 180 MPa in principle, though as described later it is important that the rotor section has a suitably long creep life. For applications where a reasonable creep life would be considered in the range of 10,000-100,000 hours of runtime, the RBSN rotor sections of the sheathless turbine assembly can operate with stresses in the range of 90-120 MPa (or, optionally, 90-100 MPa) versus 120-130 MPa for a turbine assembly with a DSN structural sheath at high temperature (for example, selected from either >1,100 C or >1,200 C).

Optionally, the outer casing 4 can be cooled externally to reduce the ceramic operating temperatures, provided that the resulting thermal stress does not offset this benefit. Conventional axial turbines use cooling via micro-channels embedded in the blades; providing exterior cooling to the outer casing 4 instead means that the rotor blades 2 and stator blades 6 do not require such channels, thus simplifying the design considerations and manufacturing process.

Optionally, the first and final rotor sections 10 may comprise, in addition to the outer rings 14, inner rotating hubs disposed towards the axis of rotation. As in other embodiments, the outer rings 14 would connect with the outer rings of 14 of the intervening rotor sections 10, optionally inside a sheath, to form the outer casing 14, whilst the inner rotating hubs of the first and final rotor sections 14 each join back to a connection with bearings at their respective ends of the turbine, said connections allowing the inner rotating hubs to rotate, causing the first and final rotor sections to rotate with them, thereby causing the entire rotor structure to rotate.

As an alternative option, the first or final rotor sections, complete with inner rotating hub, can be incorporated into the sheath to form a single large monolithic part, which can join back to the connection with bearings at one end, and that the remaining rotor parts can slide into this large monolithic part axially to complete the assembly, optionally via some form of cement or locking device, and joining back to the connection with bearings at the other end. This has the benefit of reducing the number of connecting parts between the bearings, thereby reducing the lack of concentricity at either end of the turbine, thereby prolonging bearing life and reducing the vibrational imbalance.

Optionally, the rotor sections 10 and stator sections 12 could be made from any ceramic material (or composite of) which satisfies the criteria of the turbine assembly design at the chosen rotational speed such that the advantages of the present invention over conventional metal component turbine assemblies are kept. These include negligible creep and sustained strength at high temperature (typically above 1000° C.), compatible thermal expansion for the turbine assembly, good thermal shock resistance, capability of thermal cycling and suitable to be manufactured to the target geometry. Depending on the turbine inlet temperature and pressure, the rotational speed and radial size of the turbine different ceramic materials may be suitable.

Ceramic materials that may be suitable for the turbine assembly of the present invention include, but are not limited to; the silicon carbide material family such as sintered silicon carbide (S—SiC), siliconized silicon carbide (Si—SiC), reaction bonded silicon carbide (RBSiC), nitride-bonded silicon carbide (N—SiC), recrystallized silicon carbide (Rx SiC). The choice of ceramic material, or using a composite thereof, will be directly based on the operating conditions required and as such could result in reduced efficiency or other disadvantages but may result in benefits that may include but may not be limited to, manufacturing cost, manufacturing simplicity and ability to manufacture at high volumes.

Table 1 shows a table of potential materials that could replace either the DSN sheath and/or the RBSN core depending on the properties of the material and the desired operating conditions. The creep resistance column is a qualitative description of the materials ability to resist creep. Potential cost is an approximate cost, at present, assuming the Alumina family has a baseline cost of 1, such that any sacrifice in performance of the material can be compared to potential cost saving. The process shrinkage column defines the approximate shrinkage during the most well defined manufacturing process for that material. All values in the table are approximate and typical at the time of writing. It also provides figures for Alumina, which is not a suitable material but is incorporated into the table for comparative purposes.

TABLE 1
Alternate Materials-all values are approximate and typical

| | | Room | | Potential Cost | Process | |
|---|---|---|---|---|---|---|
| Material | | Temperature | Creep | (baseline | Shrinkage | |
| Family | Variants | Strength | Resistance | Alumina) | (%) | Comments |
| Silicon | GPS SN | >700 | Good | 4.5 | ~20% | 20% shrinkage |
| Nitride | | | | | | upon densification |
| | SSN | >600 | Average | 3.5 | ~20% | 20% shrinkage |
| | | | | | | upon densification |
| | Rx SN | >400 | Very Good | 4.0 | ~20% | Crystallised grain |
| | | | | | | boundary to |
| | | | | | | minimise creep |
| | RBSN | >150 | Excellent | 2.0 | <1% | Potential for |
| | | | | | | Injection moulded |
| | | | | | | products |
| | SRBSN | >200 | Very Good | 2.5 | <10% | |
| Silicon | S SiC) | >400 | Good | 2.5 | ~20% | |
| Carbide | | | | | | |
| | N-SiC | <100 | Very Good | 2.0 | <2% | Not usually used for |
| | | | | | | engineering |
| | Rx SiC | ~100 | Excellent | 2.0 | <2% | Not usually used for |
| | | | | | | engineering |
| | Si-SiC/ | >200 | Very Good | 2.5 | <2% | Potential to |
| | RBSiC | | | | | injection mould |
| Alumina | | >300 | Poor | 1.0 | ~20% | Good high |
| | | | | | | temperature |
| | | | | | | strength, poor |
| | | | | | | thermal shock |
| | | | | | | resistance |

Alternatively, the sheath constructed from DSN in PCT/GB2017/052850 could be replaced by a Silicon Carbide sheath, or a sheath made from another ceramic or composite thereof.

Optionally RBSN, SRBSN or RBSiC could be reinforced using inserts made from a dense ceramic. The use of dense inserts allows the areas subject to higher stress to use a stronger material. For example a dense ceramic ring could be used as an insert and RBSN overmoulded to form the rotor sections. Optionally these inserts could be an appropriate fibre product such as carbon fibre of an appropriate aspect ratio. This would add strength to the rotor sections whilst maintaining the high temperature capabilities typical of a ceramic turbine. This type of reinforcement would not be limited to the rotor sections of this turbine, any rotating device requiring high temperature resistance could be utilise this type of reinforcement. For example in-runner turbines would benefit from fibre reinforcement. Use of appropriate fibre as a binder may involve a carbon fibre phenolic composite, where the phenolic is carbonised and subsequently converted to SiC and the carbon fibre binder retained in the component. Thus enabling carbon fibre structural benefits to be combined with ceramic thermal benefits.

A combination of materials as described could take advantage of shrinkage upon densification and/or thermal expansion properties between different materials to ensure the ceramic material grips the insert properly during operation. For example shrinkage upon densification could be used to grip the inserts used in overmoulding, one method this could be enacted is through controlling the sintering stage in the SRBSN manufacturing process. The opportunity of combining ceramics of appropriate properties (strength, creep resistance etc.) enables design optimisation for target duty cycles.

In the case where RBSN is used as the construction material, operating rpm, maximum radial size and specific temperature conditions can be selected to keep stresses below the 90-180 MPa range such that no structural sheath is needed. Due to the lower tip speed the present invention requires a lower rotational speed than ceramic turbines containing a DSN structural sheath, to retain the same power and efficiency, this increases the number of turbine stages, making the turbine axially longer.

Since RBSN is cheaper to manufacture than DSN, extending this over more stages and removing the sheath has a beneficial impact on cost versus the inclusion of a structural sheath. Lower speeds and low material density (and hence lower bearing loads) are more compatible with more established bearing options such as ceramic hybrid deep-groove roller bearings as provided by SKF Ltd, rather than more exotic options such as foil bearings or magnetic bearings. The lower speed also reduces bearing losses, noise and vibration.

Creep is a measure of dimensional change at a specific temperature and load. At zero load creep is minimal (below the decomposition conditions) at a given temperature. Increasing the temperature increases the propensity to creep (even under low loads, whereby the ceramic mass alone may suffice). The rate of creep at fixed load increases with temperature, once a threshold has been reached. At higher temperatures lower loads are required before high levels of creep are observed in timeframes unacceptable for an operating turbine. The maximum stress in a sheath-less turbine will occur in the outer part of the rotor section, i.e. the section with the greatest centrifugal acceleration. Above a certain stress, dependent on temperature, it becomes necessary to include a dense sheath to provide structural support to the RBSN rotor sections to avoid creep life failure occurring within a timeframe acceptable for an operating turbine. Below this boundary it is possible to construct an RBSN turbine with no sheath where the loading of the rotor sections and temperature of operation can be chosen based on creep properties of RBSN, system efficiencies and project specific constraints.

At 1250° C., the fast fracture strength of RBSN is roughly 200 MPa, and so a viable turbine with a reasonable creep life at this temperature must exhibit stresses sufficiently below 200 MPa. The rotational speed and diameter of the outermost edges of the RBSN rotor sections largely determine the stresses. Depending on the thickness of the rotor hub, the rotational speed would need to be about 250 m/s to keep stresses at 200 MPa. A viable turbine thus would need a rotational speed below this, for example at around 235 m/s, corresponding to stresses of around 180 MPa, or more preferably 175 m/s, corresponding to stresses of around 100 MPa which would be about half the fast fracture strength. This puts limits on the maximum shaft speed and diameter of the turbine and thus either requires more stages to extract the same amount of work as a larger turbine with a higher shaft speed, or requires greatly increased blade loading, in either case reducing the turbine mechanical efficiency. Such a penalty to efficiency however is possible to mitigate given the increased permissible turbine inlet temperatures.

A turbine inlet temperature of 1250° C. is seen as an appropriate temperature for an RBSN sheath-less out-runner turbine. Higher temperatures have better cycle efficiencies but poorer mechanical efficiency due to the lower material creep resistance, and hence the compromises on the turbine design (for example speed and size). The converse is true with lower temperatures. The optimum turbine inlet temperature depends on the many choices of system parameters and particular design requirements, but for the featured invention should up to 1400° C. when using RBSN as a principle turbine material, as produced using currently available processing methods, although this temperature could potentially increase with further development, or with other materials without departing from the scope of this invention.

Given the above constraints, an RBSN sheath-less out-runner turbine may be more appropriate to use in vehicles or other contexts where it is acceptable to sacrifice size and/or efficiency in return for lower unit cost. The limit on size is governed by application size constraints and by the size of the equipment required for materials processing, for example the size of an iso-static press or kiln. An RBSN sheath-less out-runner turbine thus might typically be limited by processing conditions to a rotor diameter of 400 mm; applications of sheath-less out-runner turbines may require diameters of less than 400 mm, or less than 250 mm, or less than 100 mm, or less than 50 mm.

Conversely, a ceramic out-runner turbine utilising a sheath may be more appropriate for static power generation purposes, in contexts where size is less constrained and higher unit cost is acceptable provided that the improvement in efficiency at higher temperatures and speeds results in sufficient savings. An RBSN out-runner turbine with a sheath might typically be limited by processing conditions to a rotor diameter of 400 mm, however larger diameters are readily available with appropriate processing equipment.

1: An axial out-runner turbine comprising an axially arranged series of rotor sections, wherein each rotor section comprises an outer ring and rotor blades and the outer rings of the rotor sections connect to form a rotating outer casing, wherein the rotor sections are made from silicon carbide or silicon nitride.

2: An axial out-runner turbine according to claim 1, wherein the rotor sections are made from RBSN and have a radial size selected such that at a maximum shaft speed of the turbine the radial sections experience stress no greater than 180 MPa.

3: An axial out-runner turbine according to claim 2, wherein the radial sections experience stress no greater than 100 MPa.

3. An axial out-runner turbine according to claim 1, wherein the rotor sections are made from a silicon nitride chosen from the set of gas pressure sintered silicon nitride (GPSSN), sintered silicon nitride (SSN), or Recrystallised Silicon Nitride (Rx SN).

4: An axial out-runner turbine according to claim 1, wherein the rotor sections are made from a silicon carbide chosen from the set of sintered silicon carbide (S—SiC), nitride-bonded silicon carbide (N—SiC), recrystallised silicon carbide (Rx SiC), silicon-silicon carbide (Si—SiC) or reaction bonded silicon carbide (RBSiC).

5: An axial out-runner turbine according to any of claims 1-4, wherein the rotor sections are fitted to the inside of an external sheath, the sheath and rotating outer casing being arranged to rotate together, and the sheath is made from silicon nitride or silicon carbide.

6: An axial out-runner turbine according to claim 5, wherein the sheath is made from a silicon nitride chosen from the set of dense silicon nitride (DSN), gas pressure sintered silicon nitride (GPSSN), sintered silicon nitride (SSN), Recrystallised Silicon Nitride (Rx SN), reaction bonded silicon nitride (RBSN) or sintered reaction bonded silicon nitride (SRBSN).

7: An axial out-runner turbine according to claim 5, wherein the sheath is made from a silicon carbide chosen from the set of sintered silicon carbide (S—SiC), nitride-bonded silicon carbide (N—SiC), recrystallised silicon carbide (Rx SiC), silicon-silicon carbide (Si—SiC) or reaction bonded silicon carbide (RBSiC).

8: A method of manufacturing a rotor section for an axial out-runner turbine according to any preceding claim 1-2 or 5-7, wherein the rotor section is made from RBSN and the method comprises cold pressing, casting, injection moulding, flame spraying, additive manufacturing, 3D printing, viscous plastic processing, or sol-gel methods.
